(19) United States
(12) Patent Application Publication
(10) Pub. No.: US 2022/0366182 A1
(43) Pub. Date: Nov. 17, 2022

(54) TECHNIQUES FOR DETECTION/NOTIFICATION OF PACKAGE DELIVERY AND PICKUP

(71) Applicant: Apple Inc., Cupertino, CA (US)

(72) Inventors: Mey Khalili, Mountain View, CA (US); Hendrik Dahlkamp, Redwood City, CA (US); Michael Bebenita, San Ramon, CA (US); Jonghoon Jin, Cupertino, CA (US)

(73) Assignee: Apple Inc., Cupertino, CA (US)

(21) Appl. No.: 17/485,221

(22) Filed: Sep. 24, 2021

Related U.S. Application Data
(60) Provisional application No. 63/189,515, filed on May 17, 2021.

(51) Int. Cl. G06K 9/62; G06T 7/00

(52) U.S. Cl. CPC G06K 9/627; G06T 7/97; G06T 2207/20216

(57) ABSTRACT

Systems, computer-readable media, methods, and approaches described herein may identify delivery and/or pickup of packages. For example, packages may be identified within the areas captured by images and/or video. Based on the identification of the packages, it may be determined whether the package was delivered or picked up. A notification may be initiated that indicates that a package has been delivered and/or picked up.

### CROSS-REFERENCES TO RELATED APPLICATIONS

This application claims the benefit of U.S. Provisional Patent Application No. 63/189,515, filed on May 17, 2021, the contents of which are incorporated herein by reference in its entirety for all purposes.

### BACKGROUND

As digital camera technology has become cheaper and more prevalent, it has become commonplace for cameras to be positioned outside of structures (such as residential buildings, commercial buildings, manufacturing buildings, etc.) to monitor activities occurring outside the structures, or in an unsecured portion of the structures to monitor activities occurring within the unsecured portion of the structures. For example, cameras have been implemented in door bells and security systems to monitor for activities occurring outside the structure. Additionally, the increase in online sales of goods has resulted in more packages being delivered to structures. The delivery of packages to the structures has led to challenges, including theft of the packages.

### BRIEF SUMMARY

The approaches described herein may utilize cameras to determine when packages have been delivered to or picked up from structures. In particular, a system may have one or more cameras, or may be coupled to one or more cameras, that are directed to capture video and/or images of areas where packages may be delivered or placed for pickup, such as outside of a structure, within an unsecured portion of a structure, and/or within another portion of a structure where packages may be intended to be placed for delivery and/or pickup. The cameras may be directed to areas where packages are expected to be delivered by a delivery person or placed for pickup by a delivery person. The system may identify delivery and/or pickup of packages within the video or images captured by the cameras. Based on the system identifying delivery and/or pickup of the packages, the system may determine notification settings associated with the cameras and provide notification of the delivery and/or pickup of the packages.

In some embodiments, a method may include detecting motion within video received from a camera, capturing, in response to detecting the motion, a representative image from the video, and retrieving a canonical image that represents an average of one or more frames received from the camera before detecting the motion. The method may further include determining a difference between the canonical image and the representative image, the difference identifying a set of pixels of the representative image that are different from corresponding pixels in the canonical image. Further, the method may include removing low density pixels from the set of pixels, removing high frequency pixels from the set of pixels that have a high frequency of change, and executing a flood-fill process on the set of pixels, the flood-fill process adding additional pixels causing a first subset of disjointed pixels to become contiguous. The method may further include determining a candidate age for each pixel in the set of pixels, and removing, based at least in part on the candidate age of each pixel in the set of pixels, young pixels of the set of pixels that have a candidate age that is less than a threshold. Further, the method may include executing a classifier using the set of pixels, the classifier providing a prediction of an identification of an object represented by a second subset of the set of pixels, and outputting the prediction of the identification of the object.

In some embodiments, one or more computer-readable media having instructions stored thereon, wherein the instructions, when executed by a system, may cause the system to detect motion within video received from a camera, capture, in response to detecting the motion, a representative image of an area from the video, and retrieve a canonical image of the area that represents an average of one or more frames received from the camera before detecting the motion. The instructions, when executed by the system, may further cause the system to determine a difference between the canonical image and the representative image, the difference identifying a set of pixels of the representative image that are different from corresponding pixels in the canonical image. Further, the instructions, when executed by the system, may cause the system to remove low density pixels from the set of pixels, remove high frequency pixels from the set of pixels that have a high frequency of change, and execute a flood-fill process on the set of pixels, the flood-fill process adding additional pixels causing a first subset of disjointed pixels to become contiguous. The instructions, when executed by the system, may further cause the system to determine a candidate age for each pixel in the set of pixels, and remove, based at least in part on the candidate age of each pixel in the set of pixels, young pixels of the set of pixels that have a candidate age that is less than a threshold. Further, the instructions, when executed by the system, may cause the system to execute a classifier using the set of pixels, the classifier providing a prediction of an identification of an object represented by a second subset of the set of pixels, output the prediction of the identification of the object.

In some embodiments, a system may include memory to store images from video received from a camera and one or more processors coupled to the memory. The processors may detect motion within the video, capture, from the stored images, a representative image corresponding to the detected motion, and retrieve, from the stored images, a canonical image that represents an average of one or more frames received from the camera before detection of the motion. The processors may further determine a difference between the canonical image and the representative image, the difference identifying a set of pixels of the representative image that are different from corresponding pixels in the canonical image. Further, the processors may remove low density pixels from the set of pixels, remove high frequency pixels from the set of pixels that have a high frequency of change, and execute a flood-fill process on the set of pixels, the flood-fill process adding additional pixels causing a first subset of disjointed pixels to become contiguous. The system may further determine a candidate age for each pixel in the set of pixels, and remove, based at least in part on the candidate age of each pixel in the set of pixels, young pixels of the set of pixels that have a candidate age that is less than a threshold. The processors may further execute a classifier using the set of pixels, the classifier providing a prediction of an identification of an object represented by a second subset of the set of pixels, and output the prediction of the identification of the object.

### BRIEF DESCRIPTION OF THE DRAWINGS

FIG. 1 illustrates an example system arrangement according to various embodiments.

FIG. 2 illustrates an example procedure for identifying candidates for packages in accordance with some embodiments.

FIG. 3 illustrates an example of a canonical image in accordance with some embodiments.

FIG. 4 illustrates an example of a representative image in accordance with some embodiments.

FIG. 5 illustrates an example image representation of a set of pixels produced by 208 in accordance with some embodiments.

FIG. 6 illustrates an example image representation of a set of pixels produced by 210 and 212 in accordance with some embodiments.

FIG. 7 illustrates an example image representation with bounding boxes according to some embodiments.

FIG. 8 illustrates an example image representation produced by 214 in accordance with some embodiments.

FIG. 9 illustrates an example procedure for classifying candidates and/or initiating a notification in accordance with some embodiments.

FIG. 10 illustrates a first portion of an example procedure for identification of an object in accordance with some embodiments.

FIG. 11 illustrates a second portion of the example procedure of FIG. 10 for identification of an object in accordance with some embodiments.

FIG. 12 illustrates a first portion of another example procedure for identification of an object in accordance with some embodiments.

FIG. 13 illustrates a second portion of the example procedure of FIG. 12 for identification of an object in accordance with some embodiments.

FIG. 14 illustrates an example procedure for identification of an object in accordance with some embodiments.

### DETAILED DESCRIPTION

Systems, computer-readable media, methods, and approaches described throughout this disclosure may identify delivery and/or pickup of packages. Further, a notification may be provided indicating that the package has been delivered and/or picked up. The notification may allow for a user to be aware of the delivery and/or pickup of the package, which may cause the user to retrieve the package from the area. In some instances, the notification may prevent issues presented by delivery of packages, such as theft of the packages, accidental incorrect deliveries, and/or lack of delivery of the packages.

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

### I. SYSTEM ARRANGEMENT

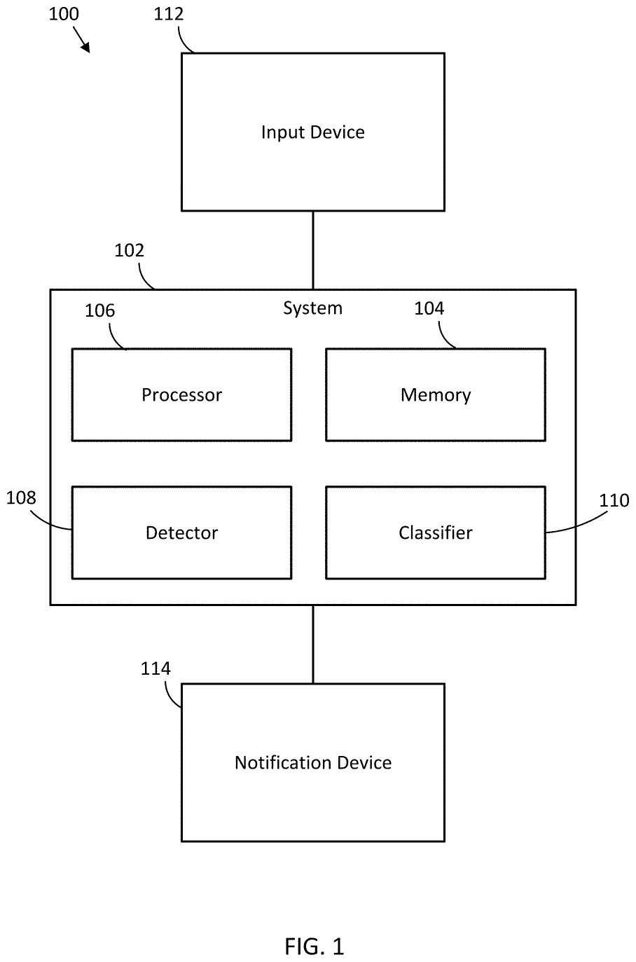

FIG. 1 illustrates an example system arrangement 100 according to various embodiments. In particular, the system arrangement 100 illustrates one example of a system 102 that may utilize one or more cameras to identify delivery and/or pickup of packages. The approaches implemented by the system can accurately and efficiently identify the delivery and/or pickup of packages. Further, the system may indicate to a user when a package has been delivered and/or picked up, which may address some of the issues of packages being placed outside of structures and/or in unsecured portions of structures, such as theft of packages.

The system arrangement 100 may include the system 102. The system 102 may comprise a computing system that may be able to execute one or more instructions to perform one or more operations. In some embodiments, the system 102 may comprise a smart doorbell, a security system, a computer system, a distributed computer system, a mobile phone (such as a smart phone), a home environment made up of various connected user devices (e.g., a home hub, controller devices, smart television systems, accessories, etc.), or portions thereof.

The system 102 may include memory 104 and one or more processors 106 coupled to the memory 104. The memory 104 may include one or more computer-readable media. In some embodiments, the computer-readable media may comprise non-transitory computer-readable media. The memory 104 may have one or more instructions stored thereon, wherein the instructions, when executed by the system 102, may cause the system 102 to perform one or more of the operations disclosed herein. The memory 104 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), flash memory, solid-state memory, any other type of memory device technology, or some combination thereof.

The processors 106 may be separate from the memory 104 and/or coupled to the memory 104, or the memory 104 may be implemented as part of the processors 106 and may be coupled to the memory 104. The processors 106 may receive the instructions from the memory 104 and execute the instructions to cause the system 102 to perform one or more of the operations described throughout this disclosure. The processors 106 may include processor circuitry such as, for example, baseband processor circuitry, central processor unit circuitry, graphics processor unit circuitry, or some combination thereof.

The system 102 may further include a detector 108. The detector 108 may comprise computer hardware components, instructions that can performed by the processors 106, or some combination thereof (which may be referred to as a “detector module” in some instances). The detector 108 may receive images and identify one or more candidates for delivery and/or pickup of a package based on the images. For example, the detector 108 may perform, or cause the system 102 to perform via the processors 106, one or more of the operations related to the identification of candidates from images described further throughout this disclosure.

The system 102 may further include a classifier 110. The classifier 110 may comprise computer hardware components, instructions that can be performed by the processors 106, or some combination thereof (which may be referred to as a “classifier module” in some instances). The classifier 110 may receive indications of the candidates within the images from the detector 108 and classify the candidates as packages, not packages, or something other than packages. For example, the classifier 110 may perform, or cause the system 102 to perform via the processors 106, one or more of the operations related to the classification of candidates from images described further throughout this disclosure.

The system arrangement 100 may further include an input device 112. In some embodiments, the input device 112 may comprise one or more cameras, where each of the cameras may capture images and/or video (which may comprise a series of images captured temporally by the camera) of an area. The areas for which the cameras are to capture images and/or videos may include areas where packages are intended to be placed for delivery and/or pickup of the packages, such as outside of structures, within unsecured portions of structures, within package depository locations, and/or other areas where packages are to be placed for delivery and/or pickup. The input device 112 may be coupled to the system 102 and may provide the captured images and/or videos to the system 102. The system 102 may store the images and/or video received from the input device 112 in the memory 104 of the system 102. In some embodiments, the images and/or portions of the video may be stored by the system 102 in the memory 104 for a period of time, where the images and/or the portions of the video may be removed from the memory 104 at the expiration of the period of time. Removing the images and/or portions of the video from the memory 104 may ensure that there is space within the memory 104 for additional images and/or portions of the video to be stored. In some embodiments, the storage of the images and/or portions of the video may be cyclical, where the oldest images and/or portions of the video may be replaced by new images and/or portions of the video received from the input device 112 (e.g., in a first in, first out (FIFO) manner).

They system arrangement 100 may further include a notification device 114. The notification device 114 may comprise a computing system such as a smart doorbell, a security system, a computer system, a distributed computer system, a mobile phone (such as a smart phone), an accessory within a home environment, a smart television (e.g., a media streaming device), or portions thereof. The notification device 114 may provide a notification to a user that delivery and/or pickup of a package has been identified or otherwise detected by the system 102. For example, the notification device 114 may be coupled to the system 102 and may receive an indication from the system 102 to provide notification that the system 102 has identified delivery and/or pickup of a package. The notification device 114 may provide a visual notification, a sound notification, a haptic notification, another type of notification, or some combination thereof to a user of the notification device 114. For example, the notification device 114 may display an image of the area with the package on a display of the notification device 114 in response to receiving the indication from the system 102 in some embodiments. In some embodiments, the notification device 114 may present the notification via email, pop-up, an application, sound from a speaker, a motion generator, or some combination thereof.

While the input device 112 and the notification device 114 are illustrated separate from the system 102 in the illustrated system arrangement 100, it should be understood that the input device 112 and/or the notification device 114 may be included in the system 102 in other embodiments. For example, the system 102 may comprise a smart doorbell or security system in some embodiments where the input device 112 comprises a camera of the smart doorbell or the security system. Further, the notification device 114 may comprise a speaker of the smart doorbell or the security system in embodiments where the system 102 comprises the smart doorbell or the security system, where the notification device 114 may emit a sound to indicate that delivery and/or pickup of a package has been detected by the system 102. For example, the notification device 114 may provide a notification by emitting an audible sound by a smart speaker (such as a home hub) or displaying a notification on a television by a media streaming device (such as a smart television).

### II. DETECTOR OPERATION

A detector of a system may process, or cause the system to process, images and/or video to identify candidates within the images and/or video of package delivery and/or pickup. For example, the system, implementing the detector, may compare a canonical image of an area from prior to detection of motion within the images and/or video with a representative image of the area after the detection of the motion to determine whether any objects have been added or removed from the area captured in the images. The detector may indicate portions of the representative image (such as by removing pixels from the representative image) to be processed by a classifier to determine whether a package has been delivered and/or picked up.

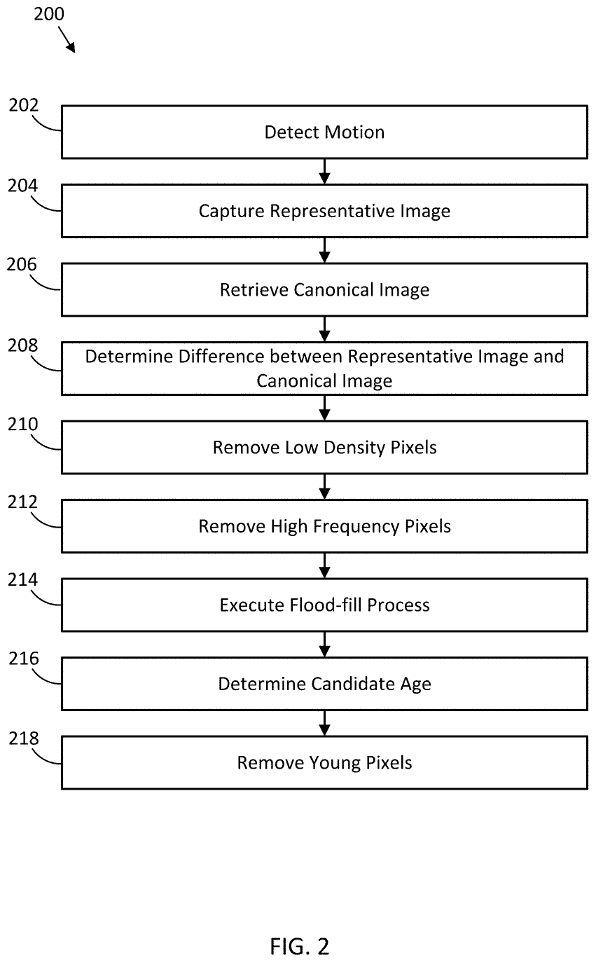

FIG. 2 illustrates an example procedure 200 for identifying candidates for packages in accordance with some embodiments. The procedure 200 may be performed by a system (such as the system 102 (FIG. 1)). For example, a detector (such as the detector 108 (FIG. 1)) may perform, or cause the system to perform, one or more of the operations of the procedure 200. The system may output candidates for packages based on the performance of the procedure 200. While the procedure 200 is illustrated in a certain order, it should be understood that one or more of the operations within the procedure 200 may be performed in a different order, concurrently with other operations, and/or may be omitted.

In 202, the system may detect motion within images and/or video received from a camera (such as the input device 112 (FIG. 1)). For example, the system may have received images and/or video from the camera and stored the received images within a memory (such as the memory 104 (FIG. 1)) of the system. Upon receiving an image from the camera, the system may compare the image with a consecutive image captured prior to the image to determine whether there are differences in the area captured within the image and the consecutive image. The system may determine that there are differences in the area based on corresponding pixels within the image and the consecutive image having differences in value or values greater than a threshold amount. For example, the differences in value or values may be value or values indicating a color of the corresponding pixels in the image and the consecutive image. In some embodiments, the system may further determine that a number of contiguous pixels within the image and consecutive image that have difference in value or values is greater than a threshold number of contiguous pixels to determine that there are differences in the area. Further, in response to determining that the image and the consecutive image have corresponding pixels with different values, the system may compare the consecutive image with one or more subsequent images to determine whether the differences, or other related differences, are presented for a certain period of time to determine that there are differences in the area. Based on the system determining that there are differences within the area, the system may determine that motion exists within the images and/or video. Accordingly, the system may detect motion with the images and/or video based on the determination that motion exists within the images and/or video.

In 204, the system may capture a representative image. The system may capture the representative image from the images and/or video received from camera in response to the detection of the motion in 202. The representative image may be an image captured by the camera after completion of the motion detected in 202. For example, the system may compare consecutive images captured by the camera after the detection of the motion to determine whether the consecutive images are determined to present differences, such as the differences described in relation to 202. Based on a certain number of the consecutive images not presenting differences, the system may determine that the motion detected in 202 has completed. The system may retrieve an image captured after the motion has completed from memory and utilize the retrieved image as the representative image that has been captured. In some embodiments, the system may cause the camera to capture an image after the motion has completed, receive the captured image from the camera, and utilize the image as the representative image.

FIG. 4 illustrates an example of a representative image 400 in accordance with some embodiments. In particular, the representative image 400 is an example of a representative image that may be captured in 204. The representative image 400 may have been captured by the camera after motion within an area captured by the camera has been completed. The representative image 400 shows a package 402 in the area captured by the representative image 400 in the illustrated embodiment.

In 206, the system may retrieve a canonical image. The canonical image may represent an average of one or more frames received from the camera before the detection of the motion in 202. In particular, the frames may comprise one or more images captured by the camera prior to the detection of the motion in 202 and provided to the system. The system may average the values of each of the corresponding pixels within the frames to produce values for each of the pixels within the canonical image. The system may produce the canonical image based on the determined values for each of the pixels and store the canonical image in the memory of the system. The system may retrieve the canonical image from the memory in 206. In other embodiments, the canonical image may be an image captured by the camera prior to the detection of the motion in 202. For example, the system may retrieve an image that was captured prior to the detection of the motion in 202 from the memory of the system and utilize the image as the canonical image. The frames and/or images utilized for retrieving the canonical image may be retrieved by the system from a preroll for the camera. The preroll may comprise one or more images captured within a period of time prior to the detection of motion. In some embodiments, the period of time for the preroll may be four seconds prior to the detection of motion. The images within the preroll are often pretty static with little to no movement with the area captured by the images.

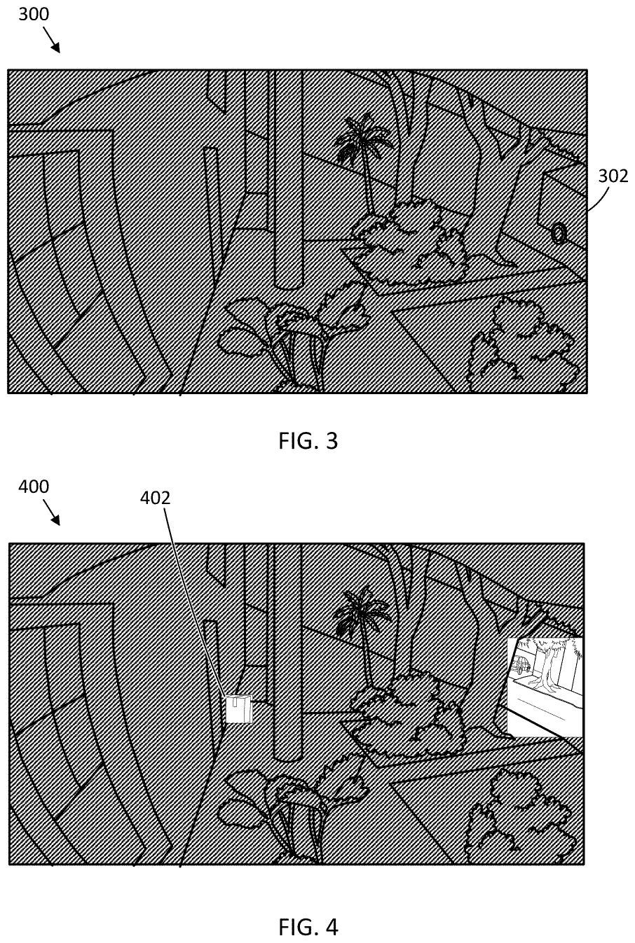

FIG. 3 illustrates an example of a canonical image 300 in accordance with some embodiments. In particular, the system may have produced the canonical image 300 by the averaging of the values of the correspond pixels with the frames as described in relation to 206. In other embodiments, the canonical image 300 may be an image that was captured prior to the detection of the motion. The area captured by the canonical image 300 may be the same area as the area captured by the representative image 400 (FIG. 4) in the illustrated embodiment. In other embodiments, the area captured by the canonical image 300 may at least partially overlap with the are captured by the representative image 400. The canonical image 300 shows a truck 302 in the area captured by the canonical image 300 in the illustrated embodiment.

In 208, the system may determine a difference between the canonical image and the representative image. For example, the system may compare the canonical image with the representative image to determine a difference between the canonical image and the representative. In particular, the system may compare values between pixels within the canonical image and corresponding pixels within the representative image to determine differences between the values of the pixels within the canonical image and the corresponding pixels within the representative image. In some embodiments, determining the differences between the values of the pixels may include determining, by the system, distances within a color space using Delta E for each of the corresponding pixels (which may be referred to as related pixels) within the representative image and the canonical image. The Delta E may be the distance metric defined by the International Commission of Illumination. The system may identify pixels as being different based on the determined distances being greater than a threshold distance. In some embodiments, the differences between the distances may be determined in a LAB color space. The LAB color space may be the color space defined by the International Commission of Illumination and may comprise three parameters, the three parameters comprising one parameter defining brightness and two parameters defining color. The difference determined by the system may identify a set of pixels of the representative image that are different from the corresponding pixels in the canonical image. The system may produce an image representation of the set of pixels determined to be different, where the image representation has pixels removed that correspond to corresponding pixels of the canonical image and the representative image that are determined not to be different.

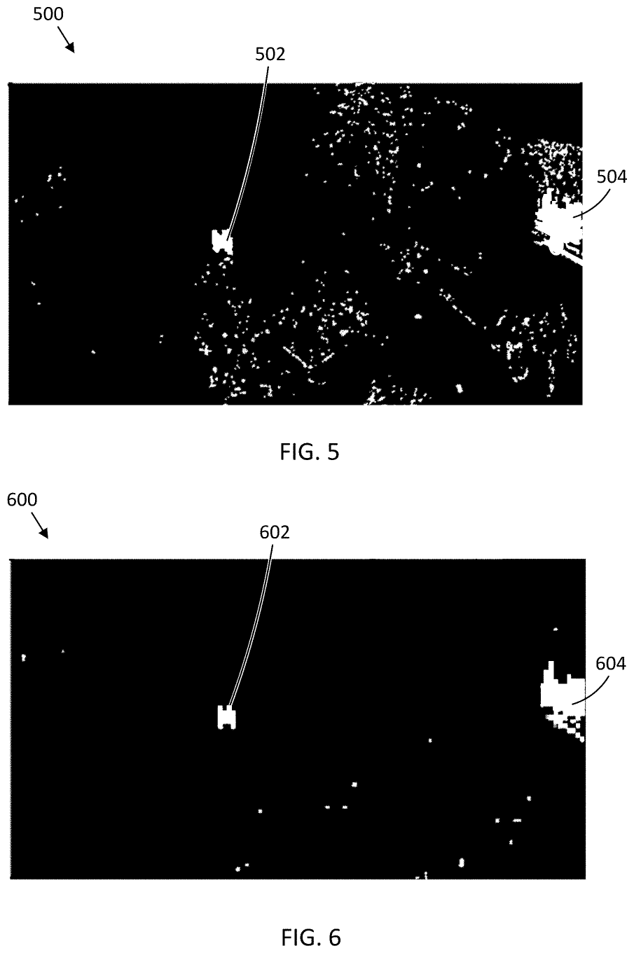

FIG. 5 illustrates an example image representation 500 of a set of pixels produced by 208 in accordance with some embodiments. In particular, the image representation 500 may indicate a set of pixels that are determined to have differed between the canonical image and the representative image. For example, the image representation 500 may have pixels determined to be different between the canonical image and the representative image shown in the image representation 500, and may have pixels determined not to be different between the canonical image and the representative image being removed from the image representation 500 (as indicated by shown in black in the image representation 500). In the illustrated embodiment, the image representation 500 includes a first group of pixels 502 and a second group of pixels 504. The first group of pixels 502 may correspond to the package 402 (FIG. 4), where the package 402 is shown in the representative image 400 (FIG. 4) and not shown in the canonical image 300 (FIG. 3). The second group of pixels 504 may correspond to the truck 302 (FIG. 3), where the truck 302 is shown in the canonical image 300 and not shown in the representative image 400.

In 210, the system may remove low density pixels. In particular, the system may remove the low density pixels from the set of pixels identified in 208. Removing the low density pixels from the set of pixels may include averaging amounts of change in subgroups of the set of pixels. For example, the system may separate the set of pixels into subgroups then average the amounts of change of the each of the pixels within the subgroups to produce an averaged amount of change for each of the subgroups. The subgroups of the set of pixels may be uniform sized or varying sizes in different embodiments. The averaged amount of change for each of the subgroups may be compared to a threshold amount of change. The system may identify a portion of the subgroups that have averaged amounts of change below the threshold amount of change. Based on a portion of the subgroups having averaged amounts of change below the threshold amount of change, the system may determine that the pixels within the portion are low density pixels. The system may remove the identified low density pixels from the set of pixels.

In other embodiments of 210, the system may keep high density pixels. In particular, the system may keep the high density pixels while removing other pixels from the set of pixels identified in 208. Keeping the high density pixels may include averaging amounts of change in subgroups of the set of pixels. For example, the system may separate the set of pixels into subgroups then average the amounts of change of each of the pixels within the subgroups to produce an averaged amount of change for each of the subgroups. The subgroups of the set of pixels may be uniform sized or varying sizes in different embodiments. The average amount of change for each of the subgroups may be compared to a threshold amount of change. The system may identify a portion of the subgroups that have averaged amounts of change above the threshold amount of change. Based on a portion of the subgroups having averaged amounts of change above the threshold amount of change, the system may determine that the pixels within the portion are high density pixels. The system may keep the high density pixels within the set of pixels while removing the other pixels from the set of pixels.

In 212, the system may remove high frequency pixels. In particular, the system may remove high frequency pixels from the set of pixels, where the high frequency pixels present a high frequency of change. The system may apply temporal averaging to the set of pixels. For example, the system may average values of the pixels within the representative image and previous frames captured by the camera within a time period prior to the representative image to determine average frequencies at which the pixels change among the representative image and the successive images. In some embodiments, the system may perform 208 and 210 for successive images within the time period in addition to performing 208 and 210 for the representative image to produce sets of pixels for the successive images. The system may then average the set of pixels from the representative image and the previous frames to determine average frequencies at which each of the pixels within the set of pixels change. The system may compare the averaged frequencies for the pixels with a threshold frequency to determine whether the pixel has been stable for the time period. For pixels with averaged frequencies above the threshold frequency, the system may determine that the pixels have been unstable within the period of time and, therefore, are high frequency pixels. The system may remove the high frequency pixels indicated by the temporal averaging.

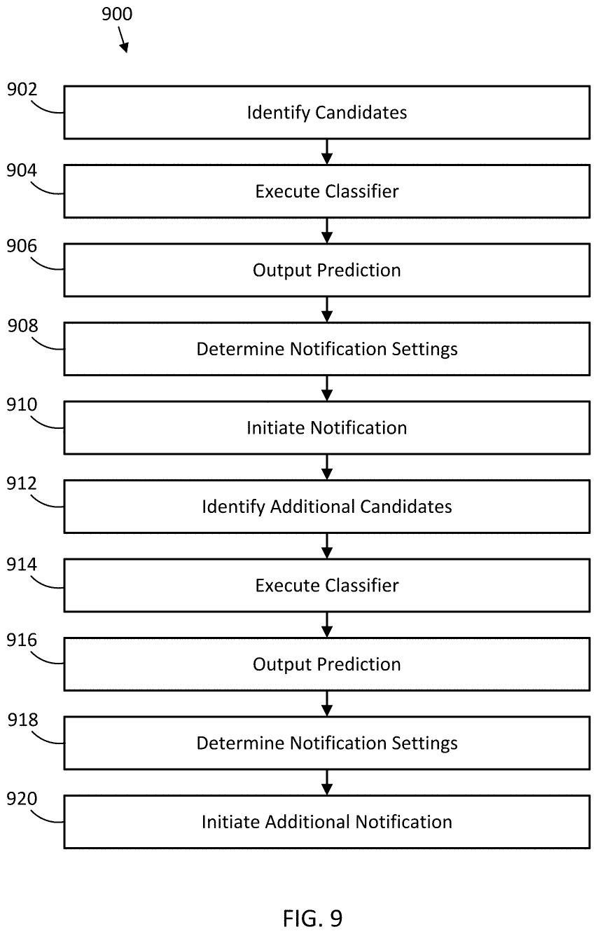

The system removing the high frequency pixels may result in modifying the set of pixels based on the previous frames to form a modified set of pixels. The modified set of pixels may be smaller than the set of pixels based on the removal of the high frequency pixels. In some embodiments, the modified set of pixels may be utilized in one or more of the operations throughout this disclosure. For example, operations 214, 216, 218, 902 (FIG. 9), 904 (FIG. 9), or some combination thereof may be performed on the modified set of pixels.

FIG. 6 illustrates an example image representation 600 of a set of pixels produced by 210 and 212 in accordance with some embodiments. In particular, the system may produce the image representation 600 by removing the low frequency pixels or keeping the high frequency pixels, in accordance with 210, and the high frequency pixels, in accordance with 212, from the image representation 500 (FIG. 5). As can be seen from the image representation 600, the image representation 600 has more pixels removed as compared to the image representation 500 while maintaining a first group of pixels 602 corresponding to the first group of pixels 502 (FIG. 5) and a second group of pixels 604 corresponding to the second group of pixels 504 (FIG. 5). The first group of pixels 602 and the second group of pixels 604 may be maintained based on the pixels not being determined to be low density pixels or being determined to be high density pixels in 210 and not being determined to be high frequency pixels in 212.

In 214, the system may perform an execute flood-fill process. The flood-fill process may add additional pixels causing a first subset of disjointed pixels to become contiguous. For example, the system may identify subsets of disjointed pixels from the set of pixels produced by 210 and 212. The system may add additional pixels to each of the subsets of disjointed pixels to cause each of the disjointed pixels to be a contiguous subset. In some embodiments, executing the flood-fill process may include generating bounding boxes around each of the disjointed pixels. For example, the bounding boxes may comprise a square, rectangle, or other shape with edges of the shape corresponding with outer bounds of the disjointed pixels. In other embodiments, the edges of the shape may be outside of the outer bounds of the disjointed pixels, where the edges may be a defined distance from the outer bounds of the disjointed pixels, sizes of the bounding box may be a defined size, sizes of the bounding boxes may be larger than an area defined by the outer bounds of the disjointed pixels by a defined percentage, or some combination thereof. In some of these embodiments, the system may compare the size of the bounding boxes with a size of the image to determine whether to remove one or more of the bounding boxes. For example, if a bounding box for a subset of disjointed pixels is larger than a first threshold percentage of the image or smaller than a second threshold percentage of the image (the second threshold percentage being less than the first threshold percentage), the system may remove the bounding box. This may prevent the system from producing candidates for a package that are too small for a package or too small for a package. This may also prevent the system from erroneously identifying the whole image as a candidate for the package, which may be caused by a change of lighting within the area. The system may add additional pixels to the bounding boxes (or the bounding boxes remaining after the removal of the bounding boxes due to size in some embodiments) to fill the bounding box. In some embodiments, adding the additional pixels may include setting the additional pixels to value of the corresponding pixels from the representative image. The system adding the additional pixels to the subsets of disjointed pixels may produce candidates for packages.

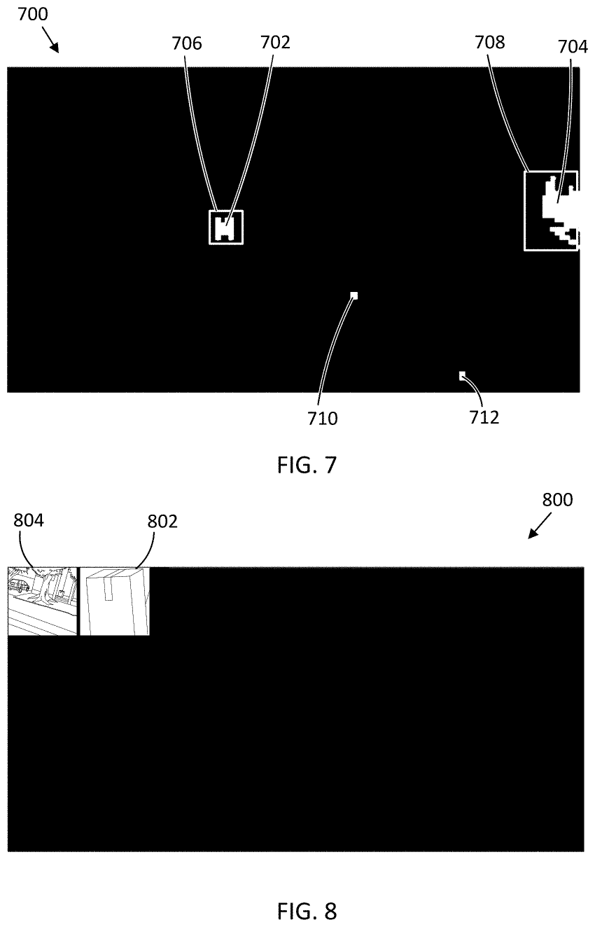

FIG. 7 illustrates an example image representation 700 with bounding boxes according to some embodiments. In particular, the image representation 700 shows example bounding boxes that may be generated by 214. For the image representation 700, the system may have performed 214 on the image representation 600 (FIG. 6) to produce the image representation 700. In the illustrated embodiment, the system may have identified a first group of pixels 702 as a first subset of disjointed pixels and a second group of pixels 704 as a second subset of disjointed pixels. The first group of pixels 702 may correspond to the first group of pixels 602 (FIG. 6), which in turn corresponds to the package 402 (FIG. 4). The second group of pixels 704 may correspond to the second group of pixels 604 (FIG. 6), which in turn corresponds to the truck 302 (FIG. 3). As used in relation to the bounding boxes, a subset of disjointed pixels may refer to a group of pixels that are not the shape and/or size of the bounding boxes. The system may generate a first bounding box 706 around the first group of pixels 702, identified as a first subset of disjointed pixels, and a second bounding box 708 around the second group of pixels 704, identified as a second subset of disjointed pixels. In some instances, the system may have identified a third group of pixels 710 as a third subset of disjointed pixels and a fourth group of pixels 712 as a fourth subset of disjointed pixels, but the system may have removed the corresponding bounding boxes based on the system determining that the corresponding bounding boxes were smaller than a threshold percentage of the image.

FIG. 8 illustrates an example image representation 800 produced by 214 in accordance with some embodiments. In particular, the system may have produced the image representation by adding additional pixels to the bounding boxes. For example, the system may have added additional pixels to fill the first bounding box 706 (FIG. 7) to produce a first candidate 802 and may have added additional pixels to fill the second bounding box 708 (FIG. 7) to produce a second candidate 804.

In 216, the system may determine candidate ages for pixels within the set of pixels. For example, the system may determine an amount of time that pixels within the set of pixels have been at a current value (or within a defined range of the current value), which may be defined as the candidate ages for the pixels. The system may compare the candidate ages of the pixels to a threshold to determine if the pixels are young pixels. The system may determine that a pixel is a young pixel based on a candidate age of the pixel being less than the threshold.

In some embodiments, the system may determine the candidate ages for subsets of disjointed pixels identified in 214 and/or pixels within the bounding boxes generated in 214. In some of these embodiments, the system may compare the candidate ages for each of the pixels within the subsets of disjointed pixels and/or the bounding boxes with the threshold to determine whether each of the pixels are young pixels. In other of these embodiments, the system may average the candidate ages of the pixels within the subsets of disjointed pixels and/or the bounding boxes and then compare the average candidate ages with the threshold to determine whether all the pixels within each of the subsets of disjointed pixels and/or bounding boxes are determined to be young pixels.

In 218, the system may remove the young pixels from the set of pixels. In particular, the system may remove the pixels determined to be young pixels in 216 from the set of pixels. Accordingly, the system may remove the young pixels from the set of pixels based on the young pixels of the set of pixels having a candidate age that is less than the threshold. In embodiments where 216 and 218 are applied to the candidates produced by 214, candidates having at least a defined percentage (which may be a majority, all, or some other percentage) of young pixels may be removed as candidates. In other embodiments, the individual pixels determined to be young pixels within the candidates may be removed leaving the rest of the pixels as part of a candidate for a package.

While the procedure 200 is described in a certain order, it should be understood that the operations of the procedure 200 may be performed in different orders and/or concurrently in some embodiments. For example, the operations 210 through 218 may be performed in different orders and/or concurrently in other embodiments.

### III. CLASSIFIER OPERATION

A classifier of a system may analyze the candidates provided from the detector and classify objects captured within the candidates as packages, not packages, or something other than packages. For example, the classifier may, or may cause the system, to apply one or more classification models to the candidates provided from the detector and indicate whether each of the candidates is a package, not a package, or something other than a package based on the classification models. The system may utilize the classification of the objects within the candidates to determine whether to provide notification that a package has been delivered or picked up.

FIG. 9 illustrates an example procedure 900 for classifying candidates and/or initiating a notification in accordance with some embodiments. The procedure 900 may be performed by a system (such as the system 102 (FIG. 1)), or a combination of a system and a notification device (such as the notification device 114 (FIG. 1)). For example, a classifier (such as the detector 110 (FIG. 1)) may perform, or cause the system to perform, one or more of the operations of the procedure 900. In some embodiments, a notification device may perform one or more of the operation of the procedure 900. The system may output a prediction for the candidates received from a detector and/or initiate a notification based on the performance of the procedure 900. While the procedure 900 is illustrated in a certain order, it should be understood that one or more of the operations within the procedure 900 may be performed in a different order, concurrently with other operations, and/or may be omitted.

In 902, the system may identify candidates for packages. In particular, the system may identify one or more candidates output by the detector on completion of the performance of the procedure 200. The system utilizing the candidates for the procedure 900 may allow the system to analyze the portions of the representative image and/or the canonical image corresponding to candidates for packages rather than analyzing an entirety of the representative image and/or the canonical image. By analyzing the portions of the representative image and/or the canonical image, the system may operate faster than if the system was to analyze the entirety of the representative image and/or the canonical image, and may provide greater accuracy in classifying packages than if the system was to analyze the entirety of the representative image and/or the canonical image.

For example, the system may identify the first candidate 802 (FIG. 8) and the second candidate 804 (FIG. 8) for the illustrated image representation 800 (FIG. 8). The first candidate 802 and the second candidate 804 may be output by the detector at the completion of the procedure 200 to the classifier, or another part of the system.

In 904, the system may execute a classifier on candidates. For example, the system may execute the classifier on the set of pixels within the candidates (which may be the set of pixels with the removed pixels and the added additional pixels from 210 through 218) to determine whether the area captured by the candidate includes a package. The classifier executed by the system may include a classification model that the system utilizes to predict if the areas captured in each of the candidates includes a package. The classification model may comprise a model produced by machine learning. The classification model may have been trained based on a training set and/or variation set to identify packages within the areas captured in each of the candidates. In some embodiments, the training of the classification model by the system may include supervised learning, where desired results for the elements within the training set and/or the variation set may be indicated to the system. In some embodiments, the system may use any machine learning technique (such as random forests, support vector machine, artificial neural networks, or some other machine learning technique) to train the classification model.

The system may determine, based on the classification model, whether the areas captured in the candidates appear to include a package and may produce predictions for each of the areas as to whether the areas include packages based on the output of the classification model. For example, if the classification model outputs an indication for any of the candidates of a representative image and/or a canonical image appears to include a package, the system may produce a prediction that the area captured in the representative image and/or the canonical image includes a package. If the classification model outputs an indication that an area corresponding to a candidate appears to not include a package, the system may produce a prediction that the area does not include a package.

In some instances, the system may identify an object within the area captured by a candidate. For example, the system may identify an object based on changes in values of the pixels within the candidate between the canonical image and the representative image. The system may apply the classification model to a subset of the set of pixels corresponding to the candidate to determine an identification of the object. The output of the classification model may indicate whether the object appears to be a package or something other than a package. The system may produce a prediction that the object is a package based on the classification model producing an indication that the object appears to be a package. Alternatively, the system may produce a prediction that the object is not a package based on the classification model producing an in indication that the object appears to be something other than a package.

In some embodiments, the system may execute the classifier on the candidate (defining the set of pixels) from the representative image provided by the detector and a corresponding set of pixels from the canonical image. The system may determine whether a package appears to be located within the area captured by the candidate in the representative image and whether the package appears to be located within the same area in the canonical image. Based on whether the classification model indicates that a package appears to be located within the area in both the representative image and the canonical image, the system may determine whether a package has been delivered or picked up. For example, if the representative image appears to have a package located within the area based on the classification model and the canonical appears not to have a package located within the area based on the classification model, the system may generate a prediction that a package has been delivered. If the representative image appears not to have a package located within the area based on the classification model and the canonical image appears to have a package located within the area based on the classification model, the system may generate a prediction that a package has been picked up.

For example, the system, based on the classification model, may determine that the area captured in the first candidate 802 (FIG. 8) appears to have a package and the second candidate 804 (FIG. 8) appears to not have a package. The system may generate a prediction that the area captured by the first candidate 802 has a package located within the area. The system may further generate a predication that the area captured by the second candidate 804 does not have a package located within the area.

In some embodiments, the system may further determine whether there are any other objects that overlap with a predicted package when the system predicts that a package has been delivered. For example, the system may analyze the candidate to determine whether there are any other objects, such as individuals and/or animals within an area of the predicted package. The system may identify the individual and/or animals based on the shape of the objects, the movement of the objects, and/or other defining characteristics of the objects detected within the area of the predicted package. In some of these embodiments, the system may identify an individual within the area of the predicted package, and may determine that the package is being carried by the individual. Based on the determination that the package is being carried by the individual, the system may determine that the package has not been delivered and determine not to initiate a notification in 910 based on the package not having been delivered.

In some embodiments, the classifier may include a classification model that the system utilizes to predict if an area within the predicted packages includes an individual or an animal. The classification model may be implemented with the same classification model as the classification model used for predicting the packages or may be a separate classification model from the classification model used for predicting the packages. The classification model may have been trained based on a training set and/or variation set to identify individuals and/or animals within the areas captured in each of the candidates. In some embodiments, the training of the classification model by the system may include supervised learning, where desired results for the elements within the training set and/or the variation set may be indicated to the system. In some embodiments, the system may use any machine learning technique (such as random forests, support vector machine, artificial neural networks, or some other machine learning technique) to train the classification model.

In some embodiments, the classifier may further compare a candidate that is predicted to include a package with corresponding pixels from an image captured at a detection of the motion within the video. For example, the system may capture an image at a time when the motion is detected within the images and/or video captured by the camera. The classifier may compare the values of the pixels for the candidate with the values for the corresponding pixels of the image captured at the time when the motion is detected. The classifier may further compensate for changes in lighting between lighting in some embodiments. For example, in comparing the values of the pixels, the system may determine the differences in values for each of the pixels. The system may determine whether the differences for each of the corresponding pixels have changed by amounts corresponding to a change in lighting. For example, if all the pixels change by approximately (within 5%) the same value and/or intensity, the system may determine that a lighting change has occurred and that the predicted package was a false positive due to the lighting changes. Accordingly, the system may predict that the candidate does not include a package based on the lighting change causing a false positive.

In 906, the system may output a prediction. For example, the system may output the prediction produced in 904. The system may output the prediction to the notification device.

In 908, the notification device may determine notification settings associated with the cameras and/or the notification device. For example, the notification device may have stored notification settings that indicate when the notification device is to initiate a notification. The notification settings may be presented to a user of the notification device and the user may indicate the events for which the notification device is to initiate a notification. In some embodiments, the notification setting may include one or more selections indicating whether the notification device is to provide a notification for a package being delivered, a package being picked up, or some combination thereof. In some embodiments, the notification settings may include one or more selections indicating a type of notification (such as a visual notification, a sound notification, a haptic notification, another type of notification, or some combination thereof) that the notification device is to utilize for the notification. The user may utilize the selections to indicate whether the notification device is to provide the notification and/or the type of notification that is to be provided. In response to the notification device receiving a prediction from the system, the notification device may review the notification settings and determine whether a notification is to be initiated and/or what type of notification is to be initiated based on the prediction.

In 910, the notification device may initiate a notification. In particular, the notification system may initiate a notification based at least in part on the predication and the determination if a notification is to be provided in 908. If the notification device determines that a notification is to be provided based on the notification settings in 908, the notification system may initiate the notification in accordance with the notification settings. If the notification device determines that a notification is not to be provided based on the notification settings in 908, 910 may be omitted. Providing the notification may include providing a notification via a smart doorbell, a security system, a computer system, a distributed computer system, a mobile phone (such as a smart phone), an accessory within a home environment, a smart television (e.g., a media streaming device), or portions thereof.

In 912, the system may identify additional candidates. For example, the system may have previously predicted that a package had been delivered and may identified additional candidates subsequently in time to the previously predicted package. The system may utilize the same procedure for identifying the subsequent candidates as identifying the candidates in 902.

In 914, the system may execute the classifier. The execution of the classifier may include one or more of the features of the execution of the classifier in 904. The classifier executed in 914 may further compare a location of the additional candidates to the locations of the previously predicted packages. If the location of the additional candidates is on top of or adjacent to the previously predicted packages, the classifier may further determine whether the additional candidates include an animal and/or an individual. For example, the classifier may utilize the classification model utilized for identifying individuals and/or animals to analyze the additional candidates. If the classification model predicts that there is an animal and/or individual located within the additional candidates, the system may output a prediction of the additional candidates being an animal and/or individual. The system may further determine not to initiate an additional notification in 918 based on the prediction of the animal and/or individual being within the additional candidates. If the system determines that an animal and/or individual is not predicted to be within the additional candidates, the system may further use the classification model for predicting whether a package is within the additional candidates. The system may determine to initiate an additional notification in 918.

In 916, the system may output a prediction. For example, the system may output the prediction produced in 914. The system may output the prediction to the notification device.

In 918, the notification device may determine notification settings associated with the cameras and/or the notification device. For example, the notification device may have stored notification settings that indicate when the notification device is to initiate a notification. The notification settings may be presented to a user of the notification device and the user may indicate the events for which the notification device is to initiate a notification. In some embodiments, the notification setting may include one or more selections indicating whether the notification device is to provide a notification for a package being delivered, a package being picked up, or some combination thereof. In some embodiments, the notification settings may include one or more selections indicating a type of notification (such as a visual notification, a sound notification, a haptic notification, another type of notification, or some combination thereof) that the notification device is to utilize for the notification. The user may utilize the selections to indicate whether the notification device is to provide the notification and/or the type of notification that is to be provided. In response to the notification device receiving a prediction from the system, the notification device may review the notification settings and determine whether a notification is to be initiated and/or what type of notification is to be initiated based on the prediction.

In 920, the notification device may initiate a notification in some instances. In particular, the notification system may initiate a notification based at least in part on the predication and the determination if a notification is to be provided in 918. If the notification device determines that a notification is to be provided based on the notification settings in 918, the notification system may initiate the notification in accordance with the notification settings. If the notification device determines that a notification is not to be provided based on the notification settings in 918, 920 may be omitted. Providing the notification may include providing a notification via a smart doorbell, a security system, a computer system, a distributed computer system, a mobile phone (such as a smart phone), an accessory within a home environment, a smart television (e.g., a media streaming device), or portions thereof.

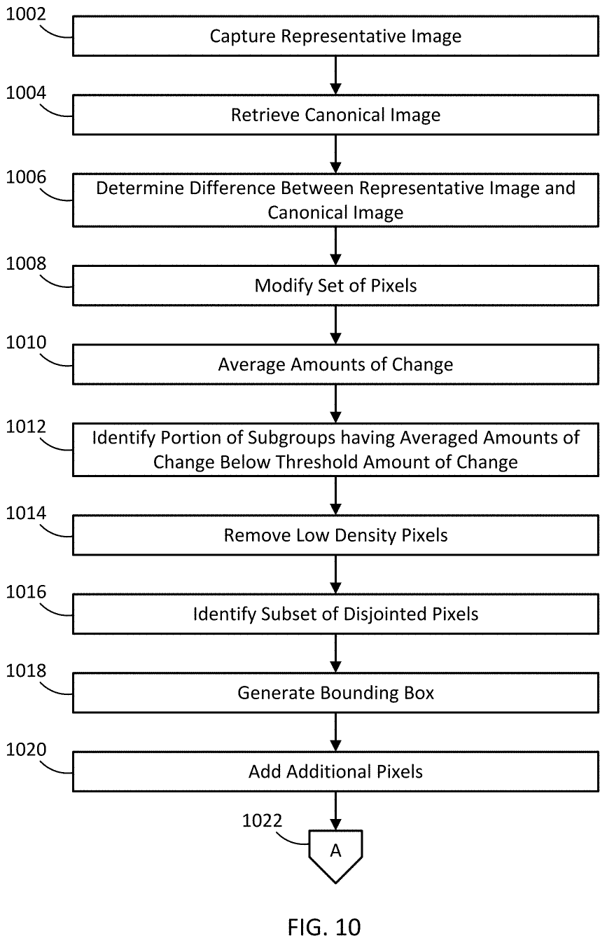

FIG. 10 illustrates a first portion of an example procedure 1000 for identification of an object in accordance with some embodiments. The procedure 1000 may be performed by a system, such as the system 102 (FIG. 1). For example, the system may receive an image and output a prediction of an identification of the object. While the procedure 1000 is illustrated in a certain order, it should be understood that one or more of the operations within the procedure 1000 may be performed in a different order, concurrently with other operations, and/or may be omitted.

In 1002, the system may capture a representative image. For example, the system may capture a representative image from a video provided to the system. The video may be captured by a camera directed to capture a particular area, where the representative image is an image of the particular area.

In 1004, the system may retrieve a canonical image. For example, the system may retrieve a canonical image that represents one or more frames of the video before the representative image. The canonical image may be an image of the same particular area as the representative image.

In 1006, the system may determine a difference between the representative image and the canonical image. For example, the system may determine a difference between the canonical image and the representative image, the identifying a set of pixels of the representative image that are different from corresponding pixels in the canonical image. The system may compare the values of the pixels within the representative image to the values of the pixels within the canonical image to determine the differences.

In some embodiments, determining the difference between the canonical image and the representative image includes determining distances within a color space using Delta E for related pixels within the representative image and the canonical image. The set of pixels that are identified as being different may be based at least in part on the determined distances within the color space. In some of these embodiments, the color space may be a LAB color space.

In 1008, the system may modify the set of pixels. For example, the system may modify the set of pixels identified in 1006 based at least in part on previous frames of the video before the representative image to form a modified set of pixels. The modified set of pixels may be smaller than the set of pixels identified in 1006.

In some embodiments, modifying the set of pixels in 1008 may include applying temporal averaging to the set of pixels. The system may identify high frequency pixels from the set of pixels based at least in part on the temporal averaging indicating that the high frequency pixels have been unstable within the previous frames. The temporal averaging may include averaging amounts of change for each pixel within the set of pixels within the previous frames, wherein the averaged amounts of change for the high frequency pixels are below a temporal averaging threshold. The system may determine that the high frequency pixels have been unstable based at least in part on the values of the high frequency pixels continually changing more than a threshold amount. The system may remove the high frequency pixels from the set of pixels based at least in part on the temporal averaging indicating that the high frequency pixels have been unstable within the previous frames.

In 1010, the system may average amounts of change. For example, the system may average amounts of change in subgroups of the set of pixels. In particular, the system may average the values of the amounts of change in the subgroups. In some embodiments, 1010 may be omitted.

In 1012, the system may identify a portion of the subgroups having averages amounts of change that are below a threshold amount of change. The pixels within the identified portion of the subgroups may be low density pixels. In some embodiments, 1012 may be omitted.

In 1014, the system may remove the low density pixels. For example, the system may remove the low density pixels identified in 1012 from the set of pixels. In some embodiments, 1014 may be omitted.

In 1016, the system may identify a subset of disjointed pixels. For example, the system may identify a subset of disjointed pixels from the modified set of pixels produced in 1008. In some embodiments, 1016 may be omitted.

In 1018, the system may generate a bounding box. For example, the system may generate a bounding box around the subset of disjointed pixels identified in 1016. In some embodiments, 1018 may be omitted.

In 1020, the system may add additional pixels. For example, the system may add additional pixels to the modified set of pixels produced in 1008 to fill the bounding box. The modified set of pixels may be used in execution of a classifier. In some embodiments, 1020 may be omitted.

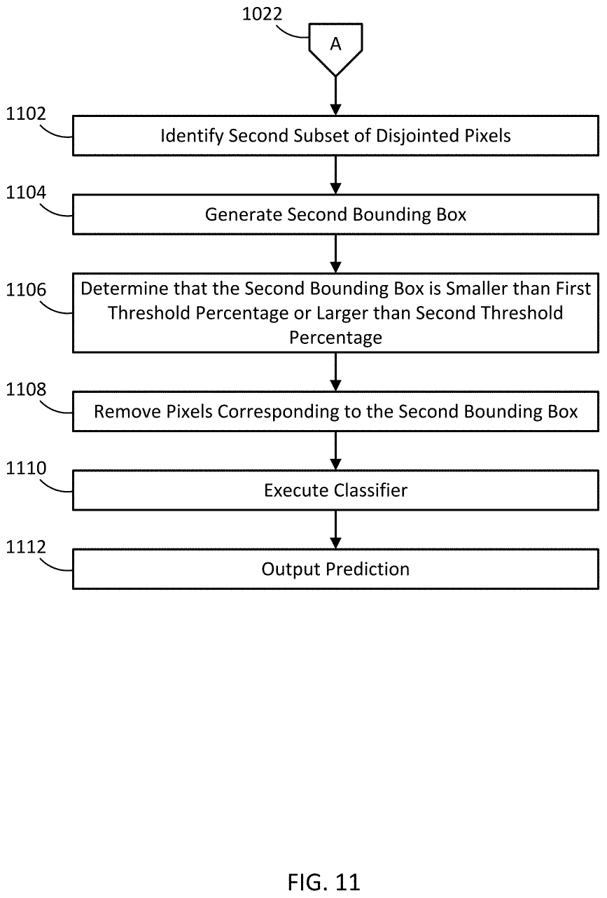

FIG. 11 illustrates a second portion of the example procedure 1000 for identification of an object in accordance with some embodiments. The procedure 1000 may proceed from 1022 illustrated in FIGS. 10 to 1022 illustrated in FIG. 11.

In 1102, the system may identify a second subset of disjointed pixels. For example, the system may identify a second subset of disjointed pixels from the modified set of pixels produced in 1008. In some embodiments, 1102 may be omitted.

In 1104, the system may generate a second bounding box. In some embodiments, the system may generate a second bounding box around the second subset of disjointed pixels. In some embodiments, 1104 may be omitted.

In 1106, the system may determine that the second bounding box is smaller than a first threshold percentage or larger than a second threshold percentage. For example, the system may determine that the second bounding box is smaller than a first threshold percentage of the representative image or larger than a second threshold percentage of the representative image. The second threshold percentage may be larger than the first threshold percentage. In some embodiments, 1106 may be omitted.

In 1108, the system may remove pixels corresponding to the second bounding box. For example, the system may remove pixels corresponding to the second bounding box from the set of pixels. A modified set of pixels with the pixels removed may be used in execution of a classifier. In some embodiments, 1108 may be omitted.

In 1110, the system may execute a classifier. For example, the system may execute a classifier using the modified set of pixels. The classifier may provide a prediction of an identification of an object represented by a subset of the modified set of pixels.

In 1112, the system may output a prediction. For example, the system may output the prediction of the identification of the object produced in 1110.

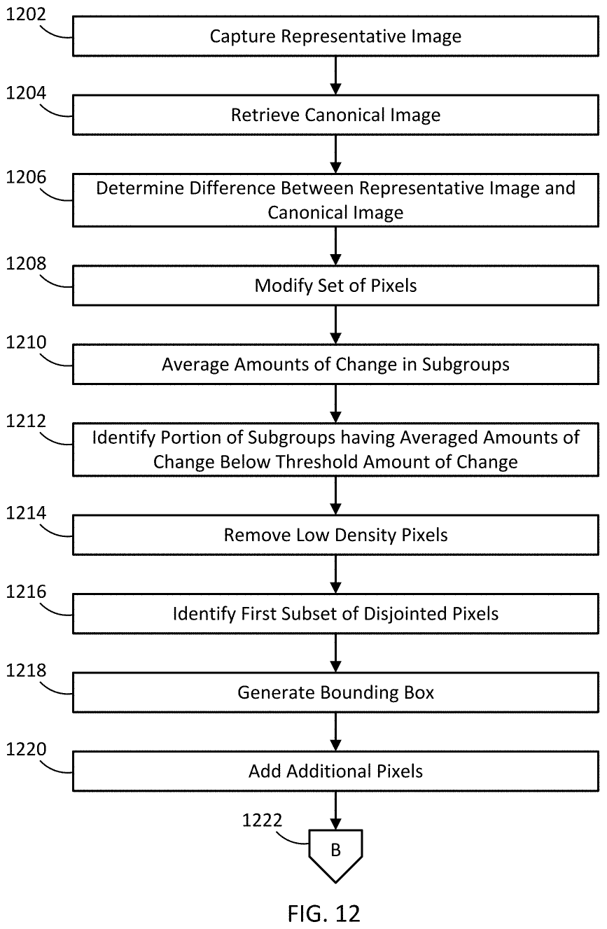

FIG. 12 illustrates a first portion of another example procedure 1200 for identification of an object in accordance with some embodiments. The procedure 1200 may be performed by a system, such as the system 102 (FIG. 1). For example, the system may receive an image and output a prediction of an identification of the object. While the procedure 1200 is illustrated in a certain order, it should be understood that one or more of the operations within the procedure 1200 may be performed in a different order, concurrently with other operations, and/or may be omitted.

In 1202, the system may capture a representative image. For example, the system may capture a representative image from a video provided to the system. The video may be captured by a camera directed to capture a particular area, where the representative image is an image of the particular area.

In 1204, the system may retrieve a canonical image. For example, the system may retrieve a canonical image that represents one or more frames of the video before the representative image. The canonical image may be an image of the same particular area as the representative image.

In 1206, the system may determine a difference between the representative image and the canonical image. For example, the system may determine a difference between the canonical image and the representative image identifying a set of pixels of the representative image that are different from corresponding pixels in the canonical image. The system may compare the values of the pixels within the representative image to the values of the pixels within the canonical image to determine the differences.

In some embodiments, determining the difference between the canonical image and the representative image includes determining distances within a color space using Delta E for related pixels within the representative image and the canonical image. The set of pixels that are identified as being different may be based at least in part on the determined distances within the color space. In some of these embodiments, the set of pixels may be identified as being different based at least in part on distances within the color space corresponding to the set of pixels being greater than a threshold distance.

In 1208, the system may modify the set of pixels. For example, the system may modify the set of pixels identified in 1206 based at least in part on previous frames of the video before the representative image to form a modified set of pixels. The modified set of pixels may be smaller than the set of pixels identified in 1206.

In some embodiments, modifying the set of pixels in 1208 may include applying temporal averaging to the set of pixels. The system may identify high frequency pixels from the set of pixels based at least in part on the temporal averaging indicating that the high frequency pixels have been unstable within the previous frames. The temporal averaging may include averaging amounts of change for each pixel within the set of pixels within the previous frames, wherein the averaged amounts of change for the high frequency pixels are below a temporal averaging threshold. The system may determine that the high frequency pixels have been unstable based at least in part on the values of the high frequency pixels continually changing more than a threshold amount. The system may remove the high frequency pixels from the set of pixels based at least in part on the temporal averaging indicating that the high frequency pixels have been unstable within the previous frames.

In 1210, the system may average amounts of change in subgroups. For example, the system may average amounts of change in subgroups of the set of pixels. In particular, the system may average the values of the amounts of change in the subgroups. In some embodiments, 1210 may be omitted.

In 1212, the system may identify a portion of the subgroups having averages amounts of change that are below a threshold amount of change. The pixels within the identified portion of the subgroups may be low density pixels. In some embodiments, 1212 may be omitted.

In 1214, the system may remove the low density pixels. For example, the system may remove the low density pixels identified in 1212 from the set of pixels. In some embodiments, 1214 may be omitted.

In 1216, the system may identify a subset of disjointed pixels. For example, the system may identify a subset of disjointed pixels from the modified set of pixels produced in 1208. In some embodiments, 1216 may be omitted.

In 1218, the system may generate a bounding box. For example, the system may generate a bounding box around the subset of disjointed pixels identified in 1216. In some embodiments, 1218 may be omitted.

In 1220, the system may add additional pixels. For example, the system may add additional pixels to the modified set of pixels produced in 1208 to fill the bounding box. The modified set of pixels may be used in execution of a classifier. In some embodiments, 1220 may be omitted.

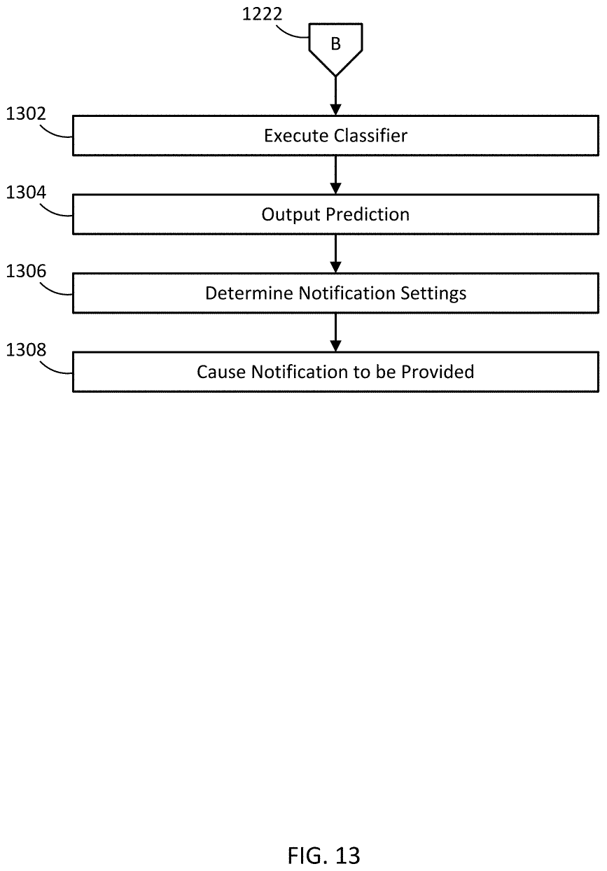

FIG. 13 illustrates a second portion of the example procedure 1200 for identification of an object in accordance with some embodiments. The procedure 1200 may proceed from 1222 illustrated in FIGS. 12 to 1222 illustrated in FIG. 13.

In 1302, the system may execute a classifier. For example, the system may execute a classifier using the modified set of pixels. The classifier may provide a prediction of an identification of an object represented by a subset of the modified set of pixels.

In 1304, the system may output a prediction. For example, the system may output the prediction of the identification of the object produced in 1302.

In 1306, the system may determine notifications. For example, the system may determine notification setting associated with a camera that captures the video indicate that a notification is to be provided when the prediction is that the object is a package. In some embodiments 1306 may be omitted.

In 1308, the system may cause a notification to be provided. For example, the system may cause the notification to be provided based at least in part on the prediction that the object is a package. The notification being provided may cause the system to emit a sound and/or display an image indicating that a package has been placed in or removed from the particular area, and/or transmitting a signal to a device that causes the device to emit a sound and/or display an image indicating that a package has been placed in or removed from the particular area.

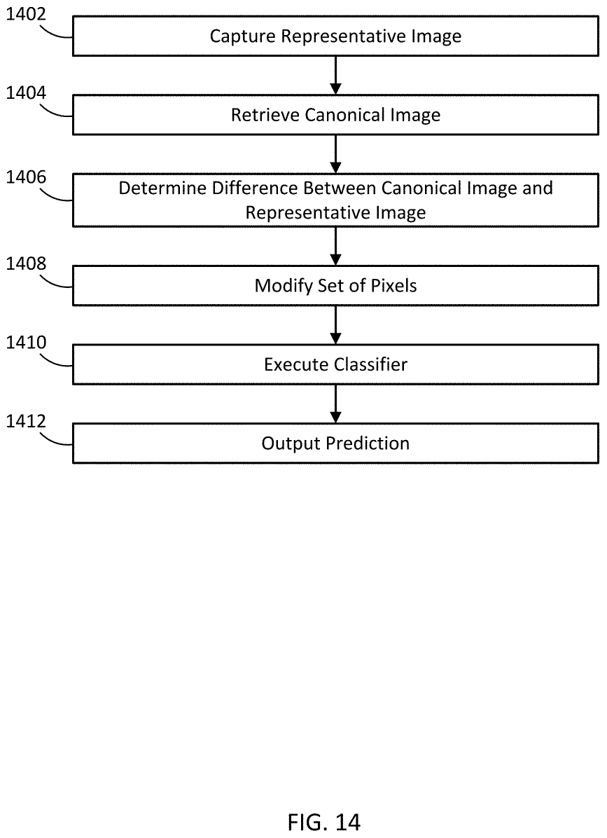

FIG. 14 illustrates an example procedure 1400 for identification of an object in accordance with some embodiments. The procedure 1400 may be performed by a system, such as the system 102 (FIG. 1). For example, the system may receive an image and output a prediction of an identification of the object. While the procedure 1400 is illustrated in a certain order, it should be understood that one or more of the operations within the procedure 1400 may be performed in a different order, concurrently with other operations, and/or may be omitted.

In 1402, the system may capture a representative image. For example, the system may capture a representative image from stored images stored by the system. The stored images may be captured by a camera directed to capture a particular area, where the representative image is an image of the particular area.

In 1404, the system may retrieve a canonical image. For example, the system may retrieve a canonical image from the stored images that represents one or more frames of the video before the representative image. The canonical image may be an image of the same particular area as the representative image.

In 1406, the system may determine a difference between the representative image and the canonical image. For example, the system may determine a difference between the canonical image and the representative image, the difference identifying a set of pixels of the representative image that are different from corresponding pixels in the canonical image. The system may compare the values of the pixels within the representative image to the values of the pixels within the canonical image to determine the differences.

In some embodiments, determining the difference between the canonical image and the representative image includes determining distances between the canonical image and the representative image in a LAB color space. The difference may be determined based at least in part on the distances.

In 1408, the system may modify the set of pixels. For example, the system may modify the set of pixels identified in 1406 based at least in part on previous frames of the video before the representative image to form a modified set of pixels. The modified set of pixels may be smaller than the set of pixels identified in 1406.

In some embodiments, modifying the set of pixels in 1208 may include applying temporal averaging to the set of pixels. The system may identify high frequency pixels from the set of pixels based at least in part on the temporal averaging indicating that the high frequency pixels have been unstable within the one or more frames. The temporal averaging may include averaging amounts of change for each pixel within the set of pixels within the one or more frames, wherein the averaged amounts of change for the high frequency pixels are below a temporal averaging threshold. The system may determine that the high frequency pixels have been unstable based at least in part on the values of the high frequency pixels continually changing more than a threshold amount. The system may remove the high frequency pixels from the set of pixels based at least in part on the temporal averaging indicating that the high frequency pixels have been unstable within the one or more frames.

In 1410, the system may execute a classifier. For example, the system may execute a classifier using the modified set of pixels. The classifier may provide a prediction of an identification of an object represented by a subset of the modified set of pixels.

In 1412, the system may output a prediction. For example, the system may output the prediction of the identification of the object produced in 1410.

### EXAMPLES

In the following sections, further exemplary embodiments are provided.

Example 1 may include a method, comprising capturing a representative image from a video, retrieving a canonical image that represents one or more frames of the video before the representative image, determining a difference between the canonical image and the representative image, the difference identifying a set of pixels of the representative image that are different from corresponding pixels in the canonical image, modifying the set of pixels based at least in part on previous frames of the video before the representative image to form a modified set of pixels, the modified set of pixels being smaller than the set of pixels, executing a classifier using the modified set of pixels, the classifier providing a prediction of an identification of an object represented by a subset of the modified set of pixels, and outputting the prediction of the identification of the object.

Example 2 may include the method of example 1, wherein determining the difference between the canonical image and the representative image includes determining distances within a color space using Delta E for related pixels within the representative image and the canonical image, and wherein the set of pixels that are identified as being different is based at least in part on the determined distances within the color space.

Example 3 may include the method of example 2, wherein the color space is a LAB color space.

Example 4 may include the method of example 1, further comprising averaging amounts of change in subgroups of the set of pixels, identifying a portion of the subgroups having averaged amounts of change that are below a threshold amount of change, wherein pixels within the portion of the subgroups comprise low density pixels, and removing the low density pixels from the set of pixels.

Example 5 may include the method of example 1, further comprising identifying a subset of disjointed pixels from the modified set of pixels, generating a bounding box around the subset of disjointed pixels, and adding additional pixels to the modified set of pixels to fill the bounding box, wherein the modified set of pixels with the additional pixels is used in the executing of the classifier.

Example 6 may include the method of example 5, wherein the subset of disjointed pixels is a first subset of disjointed pixels, and wherein the method further comprises identifying a second subset of disjointed pixels from the modified set of pixels, generating a second bounding box around the second subset of disjointed pixels, determining that the second bounding box is smaller than a first threshold percentage of the representative image or larger than a second threshold percentage of the representative image, the second threshold percentage being larger than the first threshold percentage, and removing pixels corresponding to the second bounding box from the set of pixels, wherein the modified set of pixels with the pixels removed is used in the executing of the classifier.

Example 7 may include the method of example 1, wherein modifying the set of pixels includes applying temporal averaging to the set of pixels, identifying high frequency pixels from the set of pixels based at least in part on the temporal averaging indicating that the high frequency pixels have been unstable within the previous frames, and removing the high frequency pixels from the set of pixels based at least in part on the temporal averaging indicating that the high frequency pixels have been unstable within the previous frames.

Example 8 may include the method of example 7, wherein applying the temporal averaging includes averaging amounts of change for each pixel within the set of pixels within the previous frames, and wherein the averaged amounts of change for the high frequency pixels are below a temporal averaging threshold.

Example 9 may include one or more computer-readable media having instructions stored thereon, wherein the instructions, when executed by a system, cause the system to capture a representative image of an area from a video, retrieve a canonical image of the area that represents one or more frames of the video before the representative image, determine a difference between the canonical image and the representative image, the difference identifying a set of pixels of the representative image that are different from corresponding pixels in the canonical image, modify the set of pixels based at least in part on previous frames of the video before the representative image to form a modified set of pixels, the modified set of pixels being smaller than the set of pixels, execute a classifier using the modified set of pixels, the classifier providing a prediction of an identification of an object represented by a subset of the modified set of pixels, and output the prediction of the identification of the object.

Example 10 may include the one or more computer-readable media of example 9, wherein the prediction of the object includes a prediction that the object is a package, and wherein the instructions, when executed by the system, further cause the system to determine that notification settings associated with a camera that captures the video indicate that a notification is to be provided when the prediction is that the object is a package, and cause the notification to be provided based at least in part on the prediction that the object is a package.

Example 11 may include the one or more computer-readable media of example 9, wherein to determine the difference between the canonical image and the representative image includes to determine distances within a color space using Delta E for related pixels within the canonical image and the representative image, and wherein the set of pixels that are identified as being different is based at least in part on the determined distances within the color space.

Example 12 may include the one or more computer-readable media of example 11, wherein the set of pixels that are identified as being different are identified based at least in part on distances within the color space corresponding to the set of pixels being greater than a threshold distance.

Example 13 may include the one or more computer-readable media of example 9, wherein the instructions, when executed by the system, further cause the system to average an amount of change in subgroups of the set of pixels, identify a portion of the subgroups having averaged amounts of change that are below a threshold amount of change, wherein pixels within the portion of the subgroups comprise low density pixels, and remove the low density pixels from the set of pixels.

Example 14 may include the one or more computer-readable media of example 9, wherein the instructions, when executed by the system, further cause the system to identify a first subset of disjointed pixels from the modified set of pixels, generate a bounding box around the first subset of disjointed pixels, and adding additional pixels to the modified set of pixels to fill the bounding box, wherein the modified set of pixels with the additional pixels is used in the execution of the classifier.

Example 15 may include the one or more computer-readable media of example 14, wherein to modify the set of pixels includes to apply temporal averaging to the set of pixels, identify high frequency pixels from the set of pixels based at least in part on the temporal averaging indicating that the high frequency pixels have been unstable within the previous frames, and remove the high frequency pixels based at least in part on the temporal averaging indicating that the high frequency pixels have been unstable within the previous frames.

Example 16 may include the one or more computer-readable media of example 15, wherein to apply the temporal averaging includes to average amounts of change for each pixel within the set of pixels within the previous frames, and wherein the averaged amounts of change for the high frequency pixels are below a temporal averaging threshold.

Example 17 may include a system, comprising memory to store images from video received from a camera, and one or more processors coupled to the memory, the one or more processors to capture, from stored images, a representative image, retrieve, from the stored images, a canonical image that represents one or more frames of the video before the representative image, determine a difference between the canonical image and the representative image, the difference identifying a set of pixels of the representative image that are different from corresponding pixels in the canonical image, modify the set of pixels based at least in part on previous frames of the video before the representative image to form a modified set of pixels, the modified set of pixels being smaller than the set of pixels, execute a classifier using the modified set of pixels, the classifier providing a prediction of an identification of an object represented by a subset of the modified set of pixels, and output the prediction of the identification of the object.

Example 18 may include the system of example 17, wherein to determine the difference between the canonical image and the representative image includes to determine distances between the canonical image and the representative image in a LAB color space, the difference determined based at least in part on the distances.

Example 19 may include the system of example 17, wherein to modify the set of pixels includes to apply temporal averaging to the set of pixels, identify high frequency pixels from the set of pixels based at least in part on the temporal averaging indicating that the high frequency pixels have been unstable within the one or more frames, and remove the high frequency pixels based at least in part on the temporal averaging indicating that the high frequency pixels have been unstable within the one or more frames.

Example 20 may include the system of example 19, wherein to apply the temporal averaging includes to average amounts of change for each pixel within the set of pixels within the one or more frames, and wherein the averaged amounts of change for the high frequency pixels are below a temporal averaging threshold.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a signal encoded with data as described in or related to any of examples 1-20, or portions or parts thereof, or otherwise described in the present disclosure.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

Throughout the disclosure, the terminology of “removing a pixel” and variations thereof have been used. It is to be understood that the terminology of “removing a pixel” may mean that the pixel is removed from further consideration in processing an image, may mean that the pixel is set to a certain value, may mean that the a value or values related to the pixel (such as a measurement of differences between pixel values or indication of differences between pixel values) is set to a certain value, or some combination thereof.

Throughout the disclosure, the terminology of “corresponding pixels” between two or more images and variations thereof have been used. It is to be understood that the terminology of “corresponding pixels” may refer to a first pixel within a first image at a particular position and a second pixel within a second image in the particular position. For example, a first pixel within a first row and first column of the first image may be a corresponding pixel to a second pixel within a first row and a first column of the second image. In other instances, the terminology of “corresponding pixels” may refer to a first pixel within a first image that captures a certain portion of an area captured by the first image and a second pixel within a second image that captures the certain portion of the area captured by the second image. For example, a first pixel that captures a portion of area surrounding a camera that captured may be a corresponding pixel to a second pixel that captures the same portion of the area surround the camera.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

As described above, one aspect of the present technology is the gathering and use of data (e.g., images of people) to perform facial recognition. The present disclosure contemplates that in some instances, this gathered data may include personally identifiable information (PII) data that uniquely identifies or can be used to contact or locate a specific person. Such personal information data can include facial and/or non-facial characteristics of a person's body, demographic data, location-based data (e.g., GPS coordinates), telephone numbers, email addresses, Twitter ID's, home addresses, or any other identifying or personal information.

The present disclosure recognizes that the use of such personal information data, in the present technology, can be used to the benefit of users. For example, the personal information data can be used to identify a person as being a contact (or not known contact) of a user of a user device.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of services related to performing facial recognition, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method, comprising:
capturing a representative image from a video;
retrieving a canonical image that represents one or more frames of the video before the representative image;
determining a difference between the canonical image and the representative image, the difference identifying a set of pixels of the representative image that are different from corresponding pixels in the canonical image;
modifying the set of pixels based at least in part on previous frames of the video before the representative image to form a modified set of pixels, the modified set of pixels being smaller than the set of pixels;
executing a classifier using the modified set of pixels, the classifier providing a prediction of an identification of an object represented by a subset of the modified set of pixels; and
outputting the prediction of the identification of the object.

2. The method of claim 1, wherein determining the difference between the canonical image and the representative image includes determining distances within a color space using Delta E for related pixels within the representative image and the canonical image, and wherein the set of pixels that are identified as being different is based at least in part on the determined distances within the color space.

3. The method of claim 2, wherein the color space is a LAB color space.

4. The method of claim 1, further comprising:
averaging amounts of change in subgroups of the set of pixels;
identifying a portion of the subgroups having averaged amounts of change that are below a threshold amount of change, wherein pixels within the portion of the subgroups comprise low density pixels; and
removing the low density pixels from the set of pixels.

5. The method of claim 1, further comprising:
identifying a subset of disjointed pixels from the modified set of pixels;
generating a bounding box around the subset of disjointed pixels; and
adding additional pixels to the modified set of pixels to fill the bounding box, wherein the modified set of pixels with the additional pixels is used in the executing of the classifier.

6. The method of claim 5, wherein the subset of disjointed pixels is a first subset of disjointed pixels, and wherein the method further comprises:
identifying a second subset of disjointed pixels from the modified set of pixels;
generating a second bounding box around the second subset of disjointed pixels;
determining that the second bounding box is smaller than a first threshold percentage of the representative image or larger than a second threshold percentage of the representative image, the second threshold percentage being larger than the first threshold percentage; and
removing pixels corresponding to the second bounding box from the set of pixels, wherein the modified set of pixels with the pixels removed is used in the executing of the classifier.

7. The method of claim 1, wherein modifying the set of pixels includes:
applying temporal averaging to the set of pixels;
identifying high frequency pixels from the set of pixels based at least in part on the temporal averaging indicating that the high frequency pixels have been unstable within the previous frames; and
removing the high frequency pixels from the set of pixels based at least in part on the temporal averaging indicating that the high frequency pixels have been unstable within the previous frames.

8. The method of claim 7, wherein applying the temporal averaging includes averaging amounts of change for each pixel within the set of pixels within the previous frames, and wherein the averaged amounts of change for the high frequency pixels are below a temporal averaging threshold.

9. One or more computer-readable media having instructions stored thereon, wherein the instructions, when executed by a system, cause the system to:
capture a representative image of an area from a video;
retrieve a canonical image of the area that represents one or more frames of the video before the representative image;
determine a difference between the canonical image and the representative image, the difference identifying a set of pixels of the representative image that are different from corresponding pixels in the canonical image;
modify the set of pixels based at least in part on previous frames of the video before the representative image to form a modified set of pixels, the modified set of pixels being smaller than the set of pixels;
execute a classifier using the modified set of pixels, the classifier providing a prediction of an identification of an object represented by a subset of the modified set of pixels; and
output the prediction of the identification of the object.

10. The one or more computer-readable media of claim 9, wherein the prediction of the object includes a prediction that the object is a package, and wherein the instructions, when executed by the system, further cause the system to:
determine that notification settings associated with a camera that captures the video indicate that a notification is to be provided when the prediction is that the object is a package; and
cause the notification to be provided based at least in part on the prediction that the object is a package.

11. The one or more computer-readable media of claim 9, wherein to determine the difference between the canonical image and the representative image includes to determine distances within a color space using Delta E for related pixels within the canonical image and the representative image, and wherein the set of pixels that are identified as being different is based at least in part on the determined distances within the color space.

12. The one or more computer-readable media of claim 11, wherein the set of pixels that are identified as being different are identified based at least in part on distances within the color space corresponding to the set of pixels being greater than a threshold distance.

13. The one or more computer-readable media of claim 9, wherein the instructions, when executed by the system, further cause the system to:
average an amount of change in subgroups of the set of pixels;
identify a portion of the subgroups having averaged amounts of change that are below a threshold amount of change, wherein pixels within the portion of the subgroups comprise low density pixels; and
remove the low density pixels from the set of pixels.

14. The one or more computer-readable media of claim 9, wherein the instructions, when executed by the system, further cause the system to:
identify a first subset of disjointed pixels from the modified set of pixels;
generate a bounding box around the first subset of disjointed pixels; and
adding additional pixels to the modified set of pixels to fill the bounding box, wherein the modified set of pixels with the additional pixels is used in the execution of the classifier.

15. The one or more computer-readable media of claim 14, wherein to modify the set of pixels includes to:
apply temporal averaging to the set of pixels;
identify high frequency pixels from the set of pixels based at least in part on the temporal averaging indicating that the high frequency pixels have been unstable within the previous frames; and
remove the high frequency pixels based at least in part on the temporal averaging indicating that the high frequency pixels have been unstable within the previous frames.

16. The one or more computer-readable media of claim 15, wherein to apply the temporal averaging includes to average amounts of change for each pixel within the set of pixels within the previous frames, and wherein the averaged amounts of change for the high frequency pixels are below a temporal averaging threshold.

17. A system, comprising:
memory to store images from video received from a camera; and
one or more processors coupled to the memory, the one or more processors to:
capture, from stored images, a representative image;
retrieve, from the stored images, a canonical image that represents one or more frames of the video before the representative image;
determine a difference between the canonical image and the representative image, the difference identifying a set of pixels of the representative image that are different from corresponding pixels in the canonical image;
modify the set of pixels based at least in part on previous frames of the video before the representative image to form a modified set of pixels, the modified set of pixels being smaller than the set of pixels;
execute a classifier using the modified set of pixels, the classifier providing a prediction of an identification of an object represented by a subset of the modified set of pixels; and
output the prediction of the identification of the object.

18. The system of claim 17, wherein to determine the difference between the canonical image and the representative image includes to determine distances between the canonical image and the representative image in a LAB color space, the difference determined based at least in part on the distances.

19. The system of claim 17, wherein to modify the set of pixels includes to:
apply temporal averaging to the set of pixels;
identify high frequency pixels from the set of pixels based at least in part on the temporal averaging indicating that the high frequency pixels have been unstable within the one or more frames; and
remove the high frequency pixels based at least in part on the temporal averaging indicating that the high frequency pixels have been unstable within the one or more frames.

20. The system of claim 19, wherein to apply the temporal averaging includes to average amounts of change for each pixel within the set of pixels within the one or more frames, and wherein the averaged amounts of change for the high frequency pixels are below a temporal averaging threshold.
